(19) United States
(12) Patent Application Publication
(10) Pub. No.: US 2016/0161375 A1
(43) Pub. Date: Jun. 9, 2016

(54) TEXT-MINING APPROACH FOR DIAGNOSTICS AND PROGNOSTICS USING TEMPORAL MULTIDIMENSIONAL SENSOR OBSERVATIONS

(71) Applicant: General Electric Company, Schenectady, NY (US)

(72) Inventors: Abhay Harpale, San Ramon, CA (US); Mohak Shah, San Ramon, CA (US); Abhishek Srivastav, San Ramon, CA (US)

(21) Appl. No.: 14/788,526

(22) Filed: Jun. 30, 2015

Related U.S. Application Data
(60) Provisional application No. 62/088,501, filed on Dec. 5, 2014.

(51) Int. Cl. G01M 99/00

(52) U.S. Cl. CPC G01M 99/008

(57) ABSTRACT

A system and method for text-mining to conduct diagnostics and prognostics using temporal multi-dimensional sensor observations is disclosed. A computer device stores historical time-series data for a plurality of systems. The computer device collects current time-series data from one or more sensors of a first system. The computer device compares the current time-series data to the historical time-series data to identify patterns in both the current time-series data and the historical time-series data. The computer device generates a failure likelihood prediction for the first system based on the identified patterns in the current time-series data and the historical time-series data.

### CLAIM OF PRIORITY

This application claims the benefit of priority under 35 U.S.C. §119(e) to U.S. Provisional Patent Application No. 62/088,501, filed on Dec. 5, 2014, which is hereby incorporated by reference herein in its entirety.

### TECHNICAL FIELD

The disclosed embodiments relate generally to parts maintenance and in particular to diagnostics.

### BACKGROUND

The rise in electronic and digital device technology has rapidly changed the way society interacts with media and consumes goods and services. Digital technology enables a variety of tasks to be completed that were previously very difficult or impossible. One area where electronic technology has become increasingly prevalent is in the monitoring of equipment.

For many companies, large, expensive equipment represents a significant investment and potential cost, if the equipment fails unexpectedly. One way to minimize the cost is to detect potential problems as early as possible. However, constantly monitoring equipment (especially sections that are hard to see or are only visible with partial disassembly of the equipment) is both expensive and time-consuming.

### BRIEF DESCRIPTION OF THE DRAWINGS

Some embodiments are illustrated by way of example and not limitation in the figures of the accompanying drawings, in which:

FIG. 1 is a network diagram depicting a computer device, in accordance with an example embodiment, that includes various functional components.

FIG. 2 is a block diagram illustrating a computer device, in accordance with an example embodiment.

FIG. 3 is a diagram illustrating how data is grouped such that it can be converted from time-series data into a symbolic data format.

FIG. 4 is a diagram showing an example embodiment of a process for converting symbolic data into tokenized words.

FIG. 5 is a block diagram illustrating a method, in accordance with some example embodiments, for using temporal multi-dimensional sensor observations to predict system failure based on system model data produced from past system data.

FIG. 6A is a flow diagram illustrating a method, in accordance with some example embodiments, for using collected sensor data from a live system to predict potential failure of that system using a data model.

FIG. 6B is a flow diagram illustrating a method, in accordance with some example embodiments, for using collected sensor data from a live system to predict potential failure of that system using a data model.

FIG. 7 is a block diagram illustrating an architecture of software, in accordance with an example embodiment, which may be installed on any one or more devices.

FIG. 8 is a block diagram illustrating components of a machine, in accordance with an example embodiment.

Like reference numerals refer to corresponding parts throughout the drawings.

### DETAILED DESCRIPTION

The present disclosure describes methods, systems, and computer program products for using a text-mining approach to diagnose and prognosticate failures in systems using temporal multi-dimensional sensor observations. In the following description, for purposes of explanation, numerous specific details are set forth to provide a thorough understanding of the various aspects of different embodiments. It will be evident, however, to one skilled in the art, that any particular embodiment may be practiced without all of the specific details and/or with variations, permutations, and combinations of the various features and elements described herein.

In some example embodiments, a computer system models the expected behavior of a healthy system (e.g., equipment, a person, website traffic, and so on). In some example embodiments, this model behavior is based on previous knowledge (e.g., a specification of how a piece of equipment is supposed to work) of the system or data gathered for a plurality of systems combined with a determination as to whether those systems were ultimately healthy or ultimately unhealthy (e.g., based on observed system outcomes). In some example embodiments, model behavior is generated by observing a plurality of systems over an extended period (e.g., a period of weeks or months of time) to gather information on what operating range is for a normal system and what information occurs when a system is about to fail.

For example, the healthy-state operation of a piece of equipment can either be derived from a description of the specifications of the physical or thermo-dynamical processes governing the equipment, or it can be estimated in a completely data-driven way by acquiring historical records of operation of systems that include information on whether each system failed or did not fail within a predetermined amount of time. For example, a database stores historical data for hundreds of distinct systems over the last year and a record of if each system failed and if so, when the failure occurred. This historical data is stored as a plurality of time-series data sets.

In some example embodiments, the computer system converts the raw time-series data set into a sequence by dividing the time-series data set into one or more discrete sections. The section length (in time) can be based on the total amount of time, the type of data being measured, and so on.

The data in each section is then averaged to produce an average value for each section. The average values are then placed in one of a plurality of value ranges and assigned a symbol. For example, all the values are divided into one of four ranges with respective symbols a, b, c, and d.

Once the data in the time series has been symbolized (e.g., converted into symbols), those symbols are themselves tokenized (e.g., grouped) into discrete groups of symbols (wherein groups are of a consistent number of symbols). For example, each token includes four symbols (e.g., such that each token is a four-symbol word).

The computer system uses statistical analysis (e.g., a support vector machine, Bayesian regression, and so on) and the tokens associated with a first system to determine whether the first system is a healthy system (e.g., a system that is predicted not to fail within a predetermined amount of time) or an unhealthy system (e.g., a system that is predicted to fail within a predetermined amount of time). Thus, the tokenized data for a system can be analyzed to determine which tokens (e.g., groups of symbols) best differentiate between healthy systems (e.g., equipment with no harmful flaws) and systems that will fail or have begun to fail (e.g., equipment that has begun to deteriorate), and then to determine, for a given system, whether the data associated with the system includes one or more tokens associated with either healthy systems or unhealthy systems. Ultimately, the information for the first system can be added to this historical information database along with information describing whether the system ultimately failed or not.

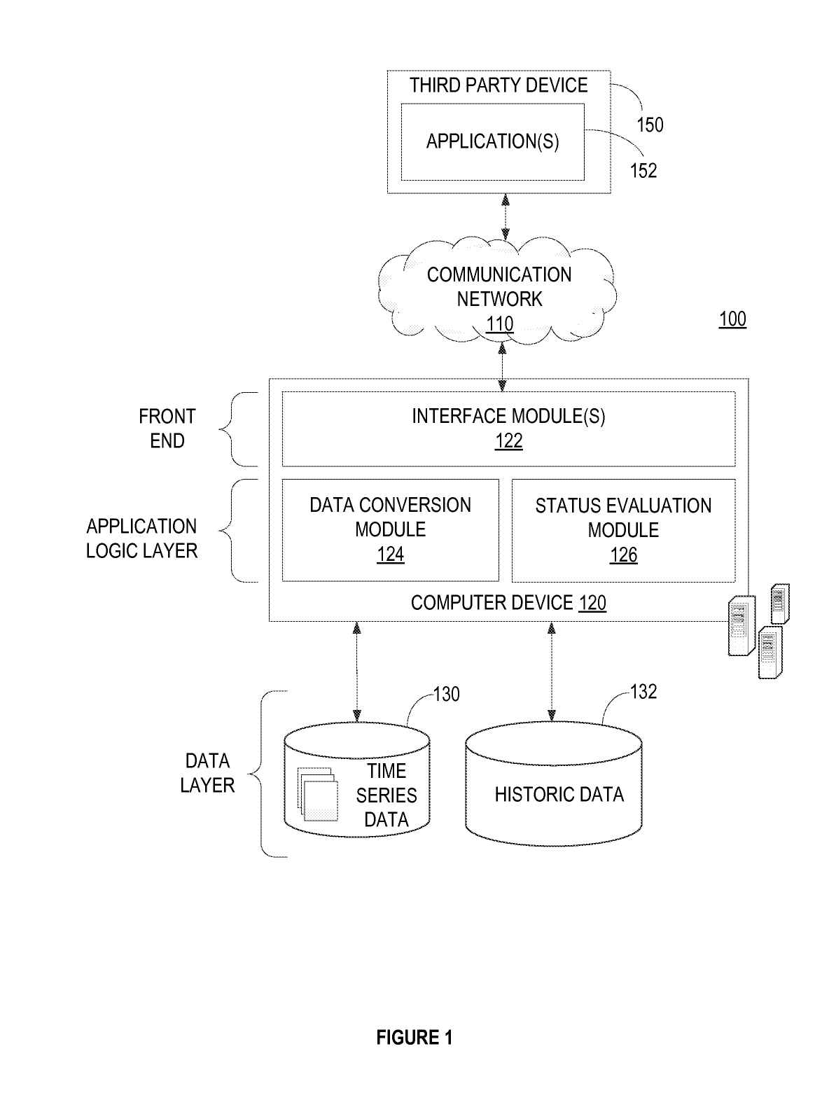

FIG. 1 is a network diagram depicting a computer device 120, in accordance with an example embodiment, that includes various functional components. In some example embodiments, the computer device 120 is part of a client-server system 100 that includes the computer device 120 and one or more third party devices 150. One or more communication networks 110 interconnect these components. The communication network 110 may be any of a variety of network types, including local area networks (LANs), wide area networks (WANs), wireless networks, wired networks, the Internet, personal area networks (PANs), or a combination of such networks.

In some embodiments, as shown in FIG. 1, the computer device 120 is generally based on a three-tiered architecture, consisting of a front-end layer, an application logic layer, and a data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various embodiments have been omitted from FIG. 1. However, a skilled artisan will readily recognize that various additional functional modules and engines may be used with a computer device 120, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although the computer device 120 is depicted in FIG. 1 as having a three-tiered architecture, the various embodiments are by no means limited to this architecture.

As shown in FIG. 1, the front-end layer consists of an interface module(s) 122, which receives input from a user through one or more input systems (e.g., a touch screen, keyboard, mouse, or other means of receiving input, including receiving input through the communication network 110), and relays responses back to the user.

As shown in FIG. 1, the data layer includes one or more databases, including databases for storing data associated with and used by the computer device 120, including time-series data 130 and historical data 132.

In some embodiments, the time-series data 130 includes data captured from one or more sensors and that represents changes in data in a system over time. For example, the time-series data 130 includes data from ten distinct sensors in a jet engine for a given time period.

In some example embodiments, the historical data 132 includes past data stored for healthy systems and broken systems that can be used to establish normal (healthy) parameters for the system values.

In some example embodiments, the computer device 120 provides a broad range of other applications and services that allow users the opportunity to share and receive information, often customized to the interests of the users.

In some embodiments, the application logic layer includes various application modules, which, in conjunction with the interface module(s) 122, generate various user interfaces to receive input from and deliver output to a user. In some embodiments, individual application modules are used to implement the functionality associated with various applications, services, and features of the computer device 120.

In addition to the various application modules, the application logic layer includes a data conversion module 124 and a status evaluation module 126. As illustrated in FIG. 1, in some embodiments, the data conversion module 124 and the status evaluation module 126 are implemented as modules that operate in conjunction with various application modules. For instance, any number of individual application modules can invoke the functionality of the data conversion module 124 and the status evaluation module 126 to convert data and queries for efficient searching. However, in various alternative embodiments, the data conversion module 124 and the status evaluation module 126 may be implemented as their own application modules such that they operate as a stand-alone application.

In some example embodiments, the data conversion module 124 accesses a set of time-series data (e.g., accesses it in memory in the time-series data 130 or receives it over the communication network 110). In some example embodiments, the data conversion module 124 divides the time-series data into one or more time segments (e.g., by time intervals). In some example embodiments, the data conversion module 124 generates an average value for each time segment in the one or more time segments.

In some example embodiments, the data conversion module 124 substitutes the average value for each time segment with a representative symbol based on the time-series data 130. In some example embodiments, the average data is first grouped into one of several discrete groups (e.g., all averages grouped into one of ten value ranges), and then a symbol (e.g., a letter such as “a” or “b”) is assigned to each of the discrete groups. In some example embodiments, the data conversion module 124 tokenizes the data by grouping individual symbols into “words” that are made up of multiple symbols.

In some example embodiments, the status evaluation module 126 uses the time-series data 130 and the historical data 132 to determine the current status of a system. In some example embodiments, the status evaluation module 126 analyzes the token data associated with the historical data 132 to create a data model that can be used to analyze each system and predict whether that system will be likely to fail within a given amount of time (e.g., a month, a year, or another period of time that is selected by the user running the analysis).

In some example embodiments, the status evaluation module 126 uses the tokens of the time-series data 130 for a first system (e.g., the tokenized data) as input for the data model and receives a likelihood (e.g., presented as a percentage) that the first system will fail within a predetermined amount of time.

In some example embodiments, a third party device 150 stores applications 152 and allows a user to connect to the computer device 120 over the communication network 110.

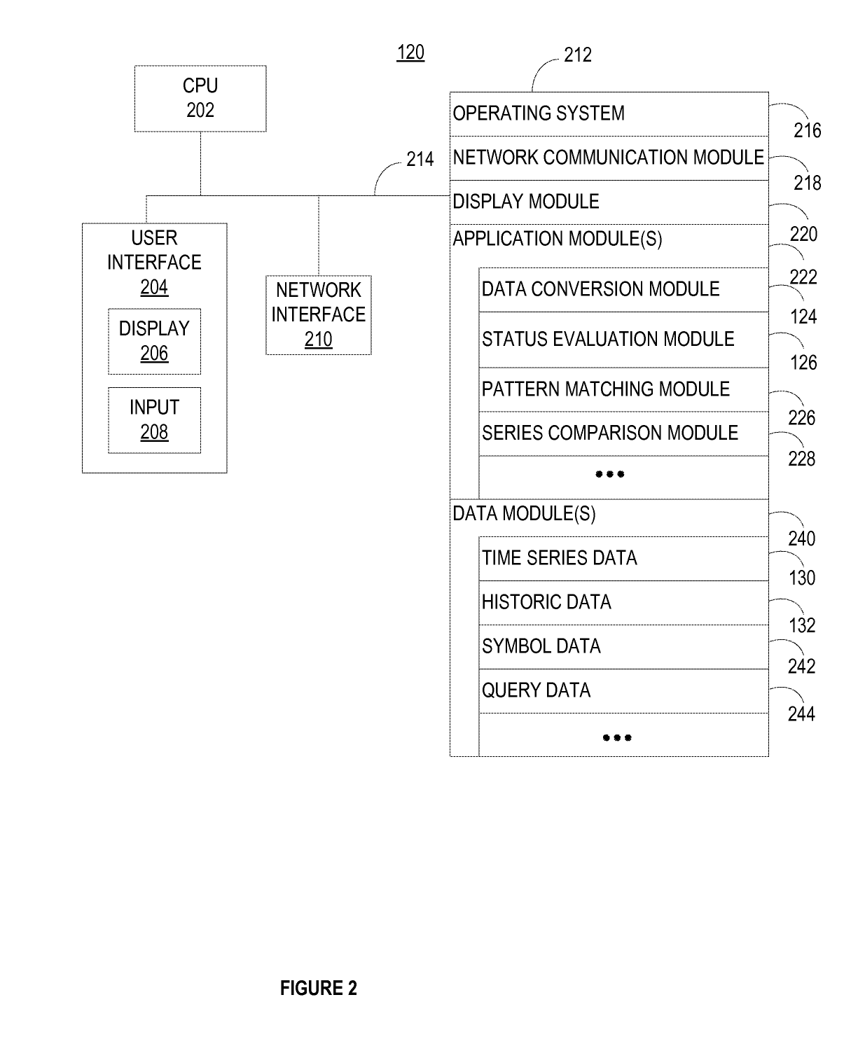

FIG. 2 is a block diagram illustrating a computer device 120, in accordance with an example embodiment. The computer device 120 typically includes one or more processing units (CPUs) 202, one or more network interfaces 210, a memory 212, and one or more communication buses 214 for interconnecting these components. The computer device 120 includes a user interface 204. The user interface 204 includes a display 206 and optionally includes an input 208, such as a keyboard, mouse, touch-sensitive display, or other input means. Furthermore, some computer devices 120 use a microphone and voice recognition to supplement or replace the keyboard.

The memory 212 includes high-speed random-access memory, such as dynamic random-access memory (DRAM), static random-access memory (SRAM), double data rate random-access memory (DDR RAM), or other random-access solid-state memory devices, and may include non-volatile memory, such as one or more magnetic disk storage devices, optical disk storage devices, flash memory devices, or other non-volatile solid-state storage devices. The memory 212 may optionally include one or more storage devices remotely located from the CPU(s) 202. The memory 212, or alternately, the non-volatile memory device(s) within the memory 212, comprise(s) a non-transitory computer readable storage medium.

In some embodiments, the memory 212 or the computer readable storage medium of the memory 212 stores the following programs, modules, and data structures, or a subset thereof:
an operating system 216 that includes procedures for handling various basic system services and for performing hardware dependent tasks;
a network communication module 218 that is used for connecting the computer device 120 to other computers via the one or more network interfaces 210 (wired or wireless) and one or more communication networks (e.g., communication network 110 of FIG. 1), such as the Internet, other wide area networks, local area networks, metropolitan area networks, etc.;
a display module 220 for enabling the information generated by the operating system 216 and application modules 222 to be presented visually on the display 206;
one or more application modules 222 for handling various aspects of providing the services associated with the computer device 120, including but not limited to:
   a data conversion module 124 for converting data from a time-series representation to a symbolic representation;
   a status evaluation module 126 for determining whether a given system is near failing;
   a pattern matching module 226 for recognizing patterns within text to determine whether the text matches (in whole or in part) a received query; and
   a series comparison module 228 for determining whether a first time-series and a second time-series include one or more patterns in common based on the value data and the corresponding time values; and
data module(s) 240, for storing data relevant to the computer device 120, including but not limited to:
   time-series data 130 for storing time-series data collected from one or more systems, wherein the time-series data includes measurements of a variable over time for a particular system (e.g., an engine where the measured variable is temperature);
   historical data 132 for storing historical data including time-series data for one or more systems wherein the outcome for each system is known (e.g., time-series data for systems that were known to fail within a specific time frame and time-series data for systems that were healthy during the same time frame);
   symbol data 242 for storing time-series data 130 that has been converted into symbolic representation format; and
   query data 244 for storing received queries and data used to convert the received queries to a format that can be used to search the symbol data 242.

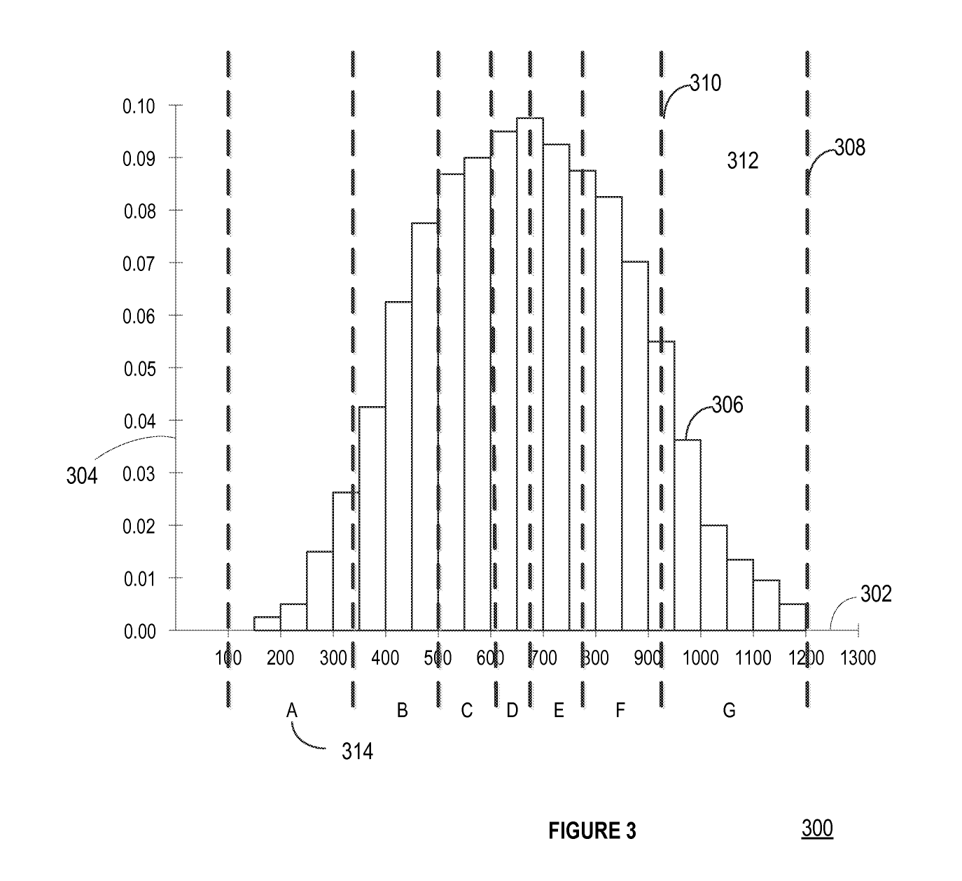

FIG. 3 is a diagram 300 illustrating how data is grouped such that it can be converted from time-series data into a symbolic data format. In this example, the data is represented as a bar graph grouping the values to determine the frequency with which certain values are achieved.

In this example, an x-axis 302 represents values associated with the temperature of an engine (as an example data set). The values can vary from 0 to 1300. A y-axis 304 represents the frequency with which a particular range of values is found. For example, a bar 306 shows that the number of times that the value was between 950 and 1000 is around 0.035 out of 1 (e.g., about 3.5 percent). These values result in a normal distribution of values (e.g., a bell curve) and the bars show which measured values are the most frequent (e.g., values near 700 are far more frequent than values near 1200 or 100).

Using these frequency values, the data is then divided into one or more symbol groups. For example, values that fall between lines 308 and 310 fall into symbol group G 312. The symbol names are listed below the x-axis 302, including symbol ‘A’ 314. The number of values that fall into each symbol group (assuming that symbol groups are determined to leave a similar number of values in each group) is one factor in determining the degree to which the computer device (e.g., the computer device 120 in FIG. 1) is able to detect possible system failures. In general, if the groups include too many values per symbol, the computer device (e.g., the computer device 120 in FIG. 1) has a hard time differentiating the dangerous signals from the normal signals, and groups that are too small (e.g., include too few values per symbol) are too granular to reveal worthwhile patterns. Thus, the size of the groups works well when finely tuned to achieve optimal results.

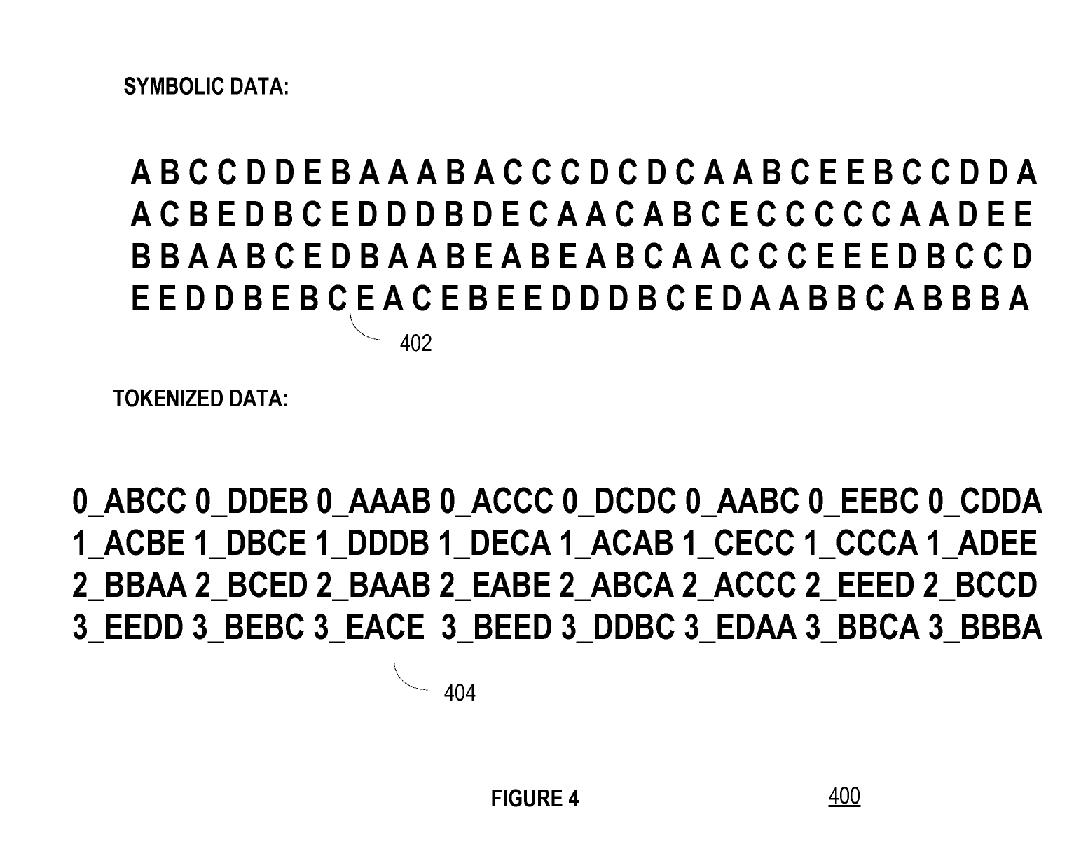

FIG. 4 is a diagram showing an example embodiment of a process for converting symbolic data into tokenized words. In this figure is an example of symbolic data 402 (e.g., time-series data that has been converted from time-series raw data into symbolic form.) Thus, each value in the time-series data has replaced by an associated symbol (in this case a letter between A and E).

In some example embodiments, the data is tokenized by grouping the symbolic data 402 into one or more words of a fixed size. In this example, the word size (e.g., the number of symbols in a token) is four. Thus, all of the symbolic data 402 has been converted into tokenized data 404 as four-symbol-long tokens. However, it is important to note that other word sizes can be used. In some example embodiments, using longer word sizes increases the granularity of the words (e.g., there are more distinct words) but reduces the number of matches for any particular word. In some example embodiments, different word lengths are used for different systems or different purposes.

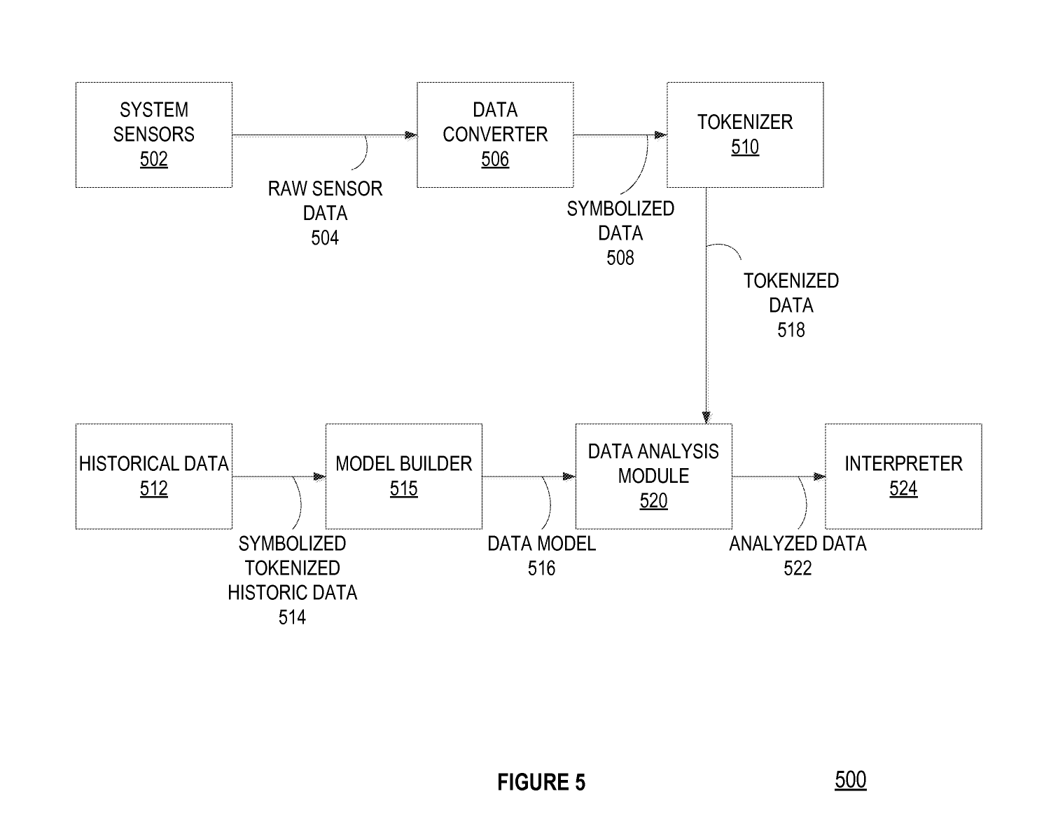

FIG. 5 is a block diagram 500 illustrating a method, in accordance with some example embodiments, for using temporal multi-dimensional sensor observations to predict system failure based on system model data produced from past system data. Each of the operations or modules shown in FIG. 5 may correspond to instructions stored in a computer memory or computer-readable storage medium. In some embodiments, the method described or represented in FIG. 5 is performed by a computer device (e.g., the computer device 120 in FIG. 1). However, the method described can also be performed by any other suitable configuration of electronic hardware.

In some embodiments, the method is performed at a computer device (e.g., the computer device 120 in FIG. 1) including one or more processors and memory storing one or more programs for execution by the one or more processors.

In some example embodiments, system sensors 502 measure data for one or more systems. In some example embodiments, the system sensors 502 are able to take measurements from a system during normal operation of the system. Thus, there is no need to take a system off-line or disassemble it in any way to read the measurements taken by the system sensors 502. For example, an engine has a set of system sensors 502 that monitor data about the engine during normal operation and record or transmit that data to a storage system.

In some example embodiments, once that internal system data has been measured by the system sensors 502, raw sensor data 504 is transmitted to a data converter 506. In some example embodiments, the data converter 506 is a component or a module of the computer device (e.g., the computer device 120 in FIG. 1). In some example embodiments, the data converter 506 takes the raw sensor data 504, often time-series data, and converts it into symbolized data 508.

In some example embodiments, this is done by associating each range of possible raw sensor data values with a specific symbol and then replacing one or more time-series values with one or more symbolic values. For example, if the raw sensor data varies between 0 and 1, that range will be broken up into 5 subsections (e.g., 0-0.2, 0.2-0.4, and so on) that are each represented by a specific symbol (e.g., “A”-“E”). In some example embodiments, a plurality of values in the time series are averaged together and the averaged value is replaced by a single symbol.

In some example embodiments, the symbolized data 508 is transmitted from the data converter 506 to a tokenizer 510. In some example embodiments, the tokenizer 510 is a component or a module of the computer device (e.g., the computer device 120 in FIG. 1). In some example embodiments, the tokenizer 510 groups symbols into a plurality of words, wherein the number of symbols in each word is fixed and is the same in all words. In some example embodiments, the number of symbols of the words is determined based on a determination made by the computer device (e.g., the computer device 120 in FIG. 1).

In some example embodiments, the tokenizer 510 sends tokenized data 518 (e.g., as a text file) to a data analysis module 520. The data analysis module 520 uses a data model 516 to determine whether the tokenized data 518 includes any tokens or group of tokens that indicate that the system is healthy, or conversely any token or group of tokens that indicate that the system is unhealthy.

In some example embodiments, the data model 516 is constructed using historical data 512. In some example embodiments, the historical data 512 is first symbolized (e.g., converted to a symbolized form by replacing raw data measurements with one or more symbols). In some example embodiments, the historical data 512 is then tokenized into a plurality of words with a fixed word length. It should be noted that the word length needs to be consistent between the data model 516 and the data to be analyzed. For example, if the data model 516 is based on four-symbol-long words, then the tokenizer 510 also uses four-symbol-long words when tokenizing data from a system to be analyzed using the data model 516.

In some example embodiments, symbolized and tokenized historical data 514 is transmitted to a model builder 515. In some example embodiments, the model builder 515 uses the symbolized and tokenized historical data 514 to build a classification model (e.g., a model that attempts to predict, for a given set of data about a system, whether the system is healthy or unhealthy). In some example embodiments, the classification model uses a support vector machine.

In some example embodiments, the model builder 515 first identifies systems that have failed in the past and systems that are healthy. The model builder 515 then analyzes the data associated with those systems to identify tokens (e.g., words) that are the most associated with unhealthy systems or healthy systems. For example, the model builder 515 identifies tokens that occur frequently in unhealthy systems and seldom in healthy systems, or vice versa. In some example embodiments, the model builder 515 calculates token counts for each system and then determines the dispositive tokens. In some example embodiments, the model builder 515 selects one or more tokens from each of a plurality of originating sensors.

In some example embodiments, the model builder 515 creates a classifier that uses the identified tokens to predict whether a given system is healthy or unhealthy (e.g., a system that is likely to fail or have a significant problem). In some example embodiments, the model builder 515 tests the created model using existing historical data 512 for which the model builder 515 does not know beforehand whether the machine failed or not. In some example embodiments, the data model is a support vector machine that uses the token data to classify systems.

In some example embodiments, once the data model 516 has been created, it is sent to the data analysis module 520. In some example embodiments, the data analysis module 520 receives the tokenized data 518 from the tokenizer 510 and the data model 516 from the model builder 515. The data analysis module 520 then determines whether the one or more tokens listed in the data model 516 are included in the tokenized data 518. In some example embodiments, the data analysis module 520 generates analyzed data 522 by determining the number of key tokens that are in the tokenized data 518, the frequency with which they occur, and the order in which they occur.

In some example embodiments, the data analysis module 520 transmits the analyzed data 522 to an interpreter 524. In some example embodiments, the interpreter 524 uses the analyzed data 522 to predict whether the particular system under review is likely to fail. In some example embodiments, the interpreter 524 analyzes the number of key tokens found in the tokenized data 518 and the order in which they appear to predict when an unhealthy system can be expected to begin to fail.

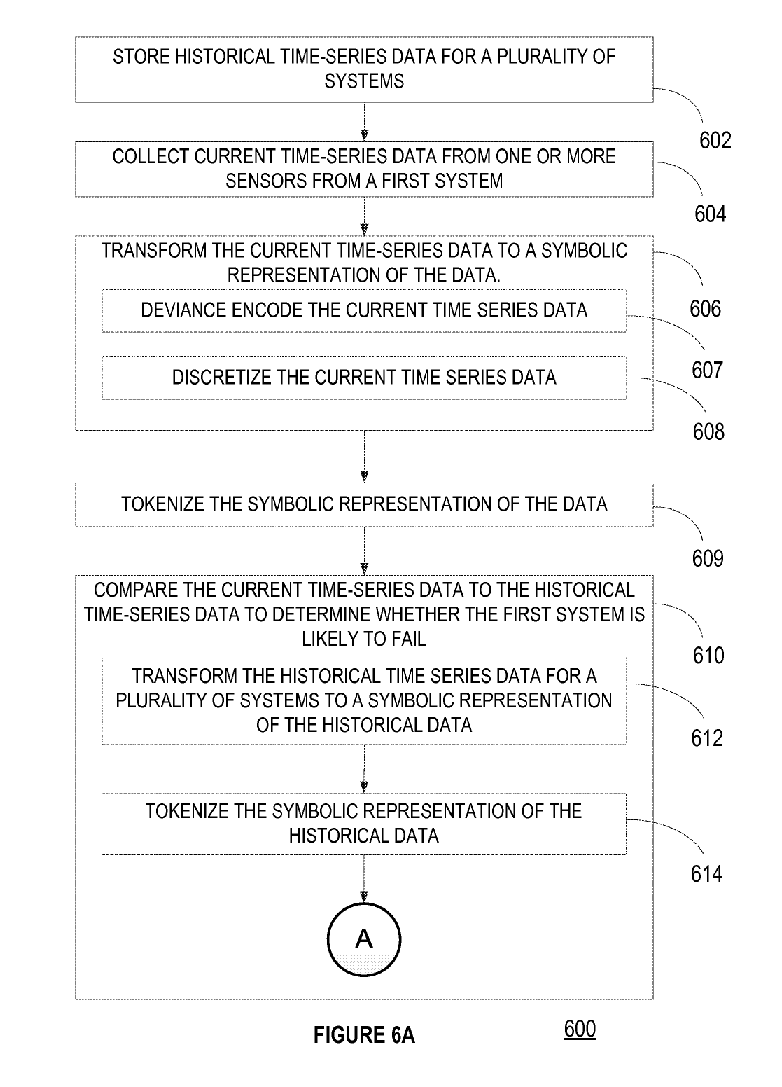

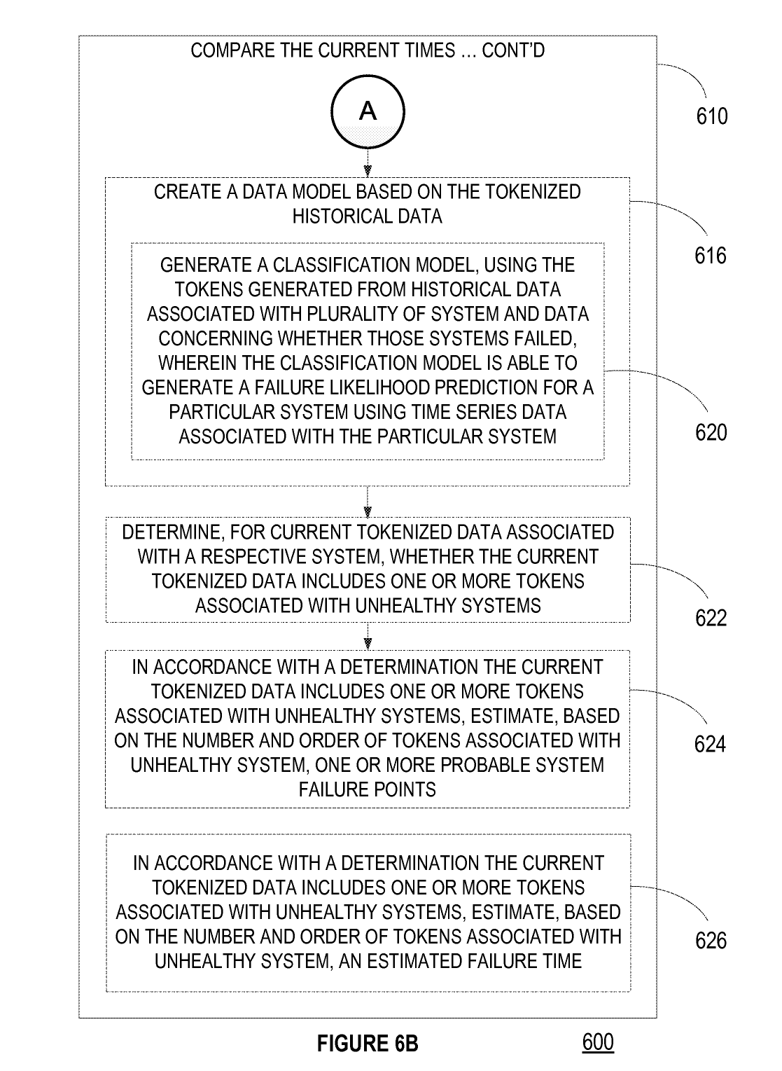

FIG. 6A is a flow diagram illustrating a method, in accordance with some example embodiments, for using collected sensor data from a live system to predict potential failure of that system using a data model. Each of the operations shown in FIG. 6A may correspond to instructions stored in a computer memory or computer-readable storage medium. Optional operations are indicated by dashed lines (e.g., boxes with dashed-line borders). In some embodiments, the method described in FIG. 6A is performed by the computer device (e.g., the computer device 120 in FIG. 1). However, the method described can also be performed by any other suitable configuration of electronic hardware.

In some embodiments, the method is performed at a computer device (e.g., the computer device 120 in FIG. 1) including one or more processors and memory storing one or more programs for execution by the one or more processors.

In some example embodiments, the computer device (e.g., the computer device 120 in FIG. 1) stores (602) historical time-series data for a plurality of systems. In some example embodiments, historical time-series data is a series of data received from one or more sensors in one or more systems (e.g., an engine). In some example embodiments, the time-series data is organized as a series of key value pairs with the key being the time the measurement was taken and the value being the measured value.

In some example embodiments, the historical time-series data for a plurality of systems include data from at least one healthy system and at least one unhealthy system. For example, the historical time-series data is stored with an indication representing whether that system ultimately experienced failure and how much time elapsed before the failure occurred. In other example embodiments, the historical data includes only data from systems that did not fail within a predefined period of time. The computer system device (e.g., the computer device 120 in FIG. 1) can then identify potentially failing systems based on determining that time series data falls outside the range determined based on the healthy systems.

In some example embodiments, the historical time-series data for a plurality of systems includes data from at least one healthy system (e.g., a system that does not fail within a predefined time period). The other systems included in the data set can be healthy systems, unhealthy systems (e.g., systems that did fail within the predefined time period), or systems where the outcome is unknown).

In other example embodiments, the historical time-series data for a plurality of systems includes data from at least one system that fails within a predefined time period (e.g., the system is unhealthy). The other systems included in the data set can be healthy systems, unhealthy systems, or systems where the outcome is unknown).

In other example embodiments, the historical time-series data for a plurality of systems includes data from systems where the outcome is unknown because the pre-defined time period of monitoring has not yet elapsed for those systems, for failure to be observed.

In some example embodiments, the computer device (e.g., the computer device 120 in FIG. 1) collects (604) current time-series data from one or more sensors from a first system. In some example embodiments, each sensor provides a separate time-series data set and the time-series data sets can be compared to determine common patterns.

In some example embodiments, after current time-series data is collected from one or more sensors from a first system, the current time-series data set is transformed (606) to a symbolic representation of the data. In some example embodiments, this is done by associating each range of possible raw sensor data values with a specific symbol and then replacing one or more time-series values with one or more symbolic values. For example, if the raw sensor data varies between 0 and 1, that range will be broken up into 5 subsections (e.g., 0-0.2, 0.2-0.4, and so on) that are each represented by a specific symbol (e.g., “A”-“E”). In some example embodiments, a plurality of values in the time series are averaged together and the averaged value is replaced by a single symbol.

In some example embodiments, converting data into symbolic form includes a deviance encoding step and a discretization step. First, as part of the deviance encoding step, the system calculates a deviance value (607) for each time-series data point. A deviance value represents the degree to which a data point deviates from the normal value range. Thus, deviance values for each particular data point a data set represent how far outside of the normal value range that particular data point is.

Once deviance encoding has been performed for a time-series data set, the deviance encoded data set is discretized (608). For example, the deviance encoded data set is divided up into a plurality of discrete value ranges. Each value range is associated with a particular symbol. In this way, each value in the deviance encoded dataset is associated with a particular symbol based on which discrete value range the value falls into. For example, FIG. 3 shows a dataset that is divided into a series of discrete value ranges. Each value range has an associated symbol and each value falls into one of the discrete value ranges.

In some example embodiments, after the current time-series data is transformed to a symbolic representation of the data, the symbolic representation of the data is tokenized (609). In some example embodiments, tokenizing includes dividing the symbolic data into a plurality of words or tokens which each include a fixed number of symbols.

However in other potential embodiments, the tokens can be composed of a variable number of symbols. For example, some tokens are three symbols long, some tokens are four symbols long, and some symbols are five symbols long. In yet other potential embodiments, the tokens have an upper limit to the number of symbols that can be included, such that tokens have a variable number of symbols under the upper limit but never above the upper limit. For example, if the upper limit was seven symbols, tokens in that system can have one through seven symbols but never eight or more.

In some example embodiments, the computer device (e.g., the computer device 120 in FIG. 1) compares (610) the current time-series data (e.g., the tokens created from the current time-series data) to the historical time-series data (e.g., the data model created from the tokenized historical data) to determine whether the first system is likely to fail. In some example embodiments, the computer device (e.g., the computer device 120 in FIG. 1) transforms (612) the historical time-series data for a plurality of systems to a symbolic representation of the historical data. In some example embodiments, the computer device (e.g., the computer device 120 in FIG. 1) tokenizes (614) the symbolic representation of the historical data.

FIG. 6B is a flow diagram illustrating a method, in accordance with some example embodiments, for using collected sensor data from a live system to predict potential failure of that system using a data model. Each of the operations shown in FIG. 6B may correspond to instructions stored in a computer memory or computer-readable storage medium. Optional operations are indicated by dashed lines (e.g., boxes with dashed-line borders). In some embodiments, the method described in FIG. 6B is performed by the computer device (e.g., the computer device 120 in FIG. 1). However, the method described can also be performed by any other suitable configuration of electronic hardware.

In some embodiments, the method is performed at a computer device (e.g., the computer device 120 in FIG. 1) including one or more processors and memory storing one or more programs for execution by the one or more processors.

In some example embodiments, the computer device (e.g., the computer device 120 in FIG. 1) creates (616) a data model based on the tokenized historical data.

In some example embodiments, creating a model includes, for a plurality of systems for which historical data is stored, determining whether the system failed or did not fail within a given time period. For the group of systems that are determined to have failed within a given time, the computer device (e.g., the computer device 120 in FIG. 1) determines all the tokens that appear, the frequency of the tokens, and the order in which they appear.

In some example embodiments, the computer device (e.g., the computer device 120 in FIG. 1) similarly determines all the tokens that appear, the frequency of the tokens, and the order in which they appear for all the systems that did not fail within a given time period. The computer device (e.g., the computer device 120 in FIG. 1) can then compare the two groups to identify one or more tokens, token frequencies, or token orders that are associated with systems that fail but not system that do not fail.

In some example embodiments, the computer device (e.g., the computer device 120 in FIG. 1) builds a support vector machine that uses the tokenized historical data (as training data) to recognize patterns (e.g., in the tokens associated with each system). In some example embodiments, the support vector machine is trained with historical data and then tested or verified using other historical data (e.g., to determine whether the support vector machine gives the correct classification).

In some example embodiments, the computer device (e.g., the computer device 120 in FIG. 1) determines, for each token, whether the token is associated with a healthy system (e.g., systems that do not have a high chance of failure in a given period of time) or an unhealthy system (e.g., systems that have one or more faulty components or system failures that cause the system to fail or be very likely to fail).

In some example embodiments, the computer device (e.g., the computer device 120 in FIG. 1) generates (620) a classification model, using the tokens generated from historical data associated with plurality of system and data concerning whether those systems failed, wherein the classification model is able to generate a failure likelihood prediction for a particular system using time series data associated with the particular system. In some example embodiments, while generating a classification model, the computer device (e.g., the computer device 120 in FIG. 1) identifies one or more tokens that are associated with (or indicative of) a unhealthy or failing system. These tokens are identified as the classification model is generated and are based on an analysis of the historical time-series data. For example, the computer device (e.g., the computer device 120 in FIG. 1) determines, one or more tokens that are commonly found in systems that fail within 30 days but not found in systems that remain healthy. The computer device (e.g., the computer device 120 in FIG. 1) then identifies the one or more tokens as indicative of an unhealthy system.

In some example embodiments, the classification model is a support vector machine. In some example embodiments, other classification techniques can be used including, but not limited to discriminative classifiers like Logistic Regression, Tree-based approaches, generative classifiers like Naïve Bayes, Probabilistic Graphical Models, ensemble based approaches such as Random Forest, or instance based learners like Nearest Neighbor classifiers.

In some example embodiments, the computer device (e.g., the computer device 120 in FIG. 1) determines (622), for current tokenized data associated with the first system, whether the current tokenized data includes one or more tokens (or token patterns) associated with unhealthy systems.

In some example embodiments, in accordance with a determination that the current tokenized data includes one or more tokens associated with unhealthy systems, the computer device (e.g., the computer device 120 in FIG. 1) estimates (624), based on the number and order of tokens associated with unhealthy systems, one or more probable system failure points.

In some example embodiments, the computer device (e.g., the computer device 120 in FIG. 1) compares the current time-series data to the historical time-series data to identify patterns in both the current time-series data and the historical time-series data. The computer device generates a failure likelihood prediction for the first system based on the identified patterns in the current time-series and the historical time-series data. In some cases, the failure likelihood prediction is a prognosticative in that it predicts future failure, even when the system is not currently failing (e.g., not currently performing below standards). Thus the failure likelihood prediction gives a percentage that a system will fail in a given amount of time (e.g., 80% chance of failure in the next 60 days). In this way, the system can predict the failure of systems before those systems actually start to fail, allowing efficient use of resources to maintain those systems.

In other example embodiments, the failure likelihood prediction identifies systems that are currently failing (e.g., a diagnostic function). Thus, the failure likelihood prediction represents the likelihood that a given system is currently failing, based on the gather time-series data for that system. For example, the failure likelihood prediction for System A determines that there is a less than three percent chance that System A is currently failing (e.g., it has problems sufficient to cause performance to be below an acceptable standard). However, the failure likelihood prediction for System B is that there is a ninety percent chance that is currently failing.

In some example embodiments, the failure likelihood prediction can be used to represent both the likelihood is currently failing and the likelihood that the system will fail in the future.

In some example embodiments, in accordance with a determination that the current tokenized data includes one or more tokens associated with unhealthy systems, the computer device (e.g., the computer device 120 in FIG. 1) estimates (626), based on the number and order of tokens associated with unhealthy systems, a failure time.

For example, the data model is a support vector machine (SVM) that uses information about an engine to determine whether the engine is likely to fail within the next month. The SVM analyses tokenized data from a plurality of engines to predict whether each engine will fail in the next month. Based on those predictions, a company can perform maintenance on engines that need it before those engines fail.

### Software Architecture

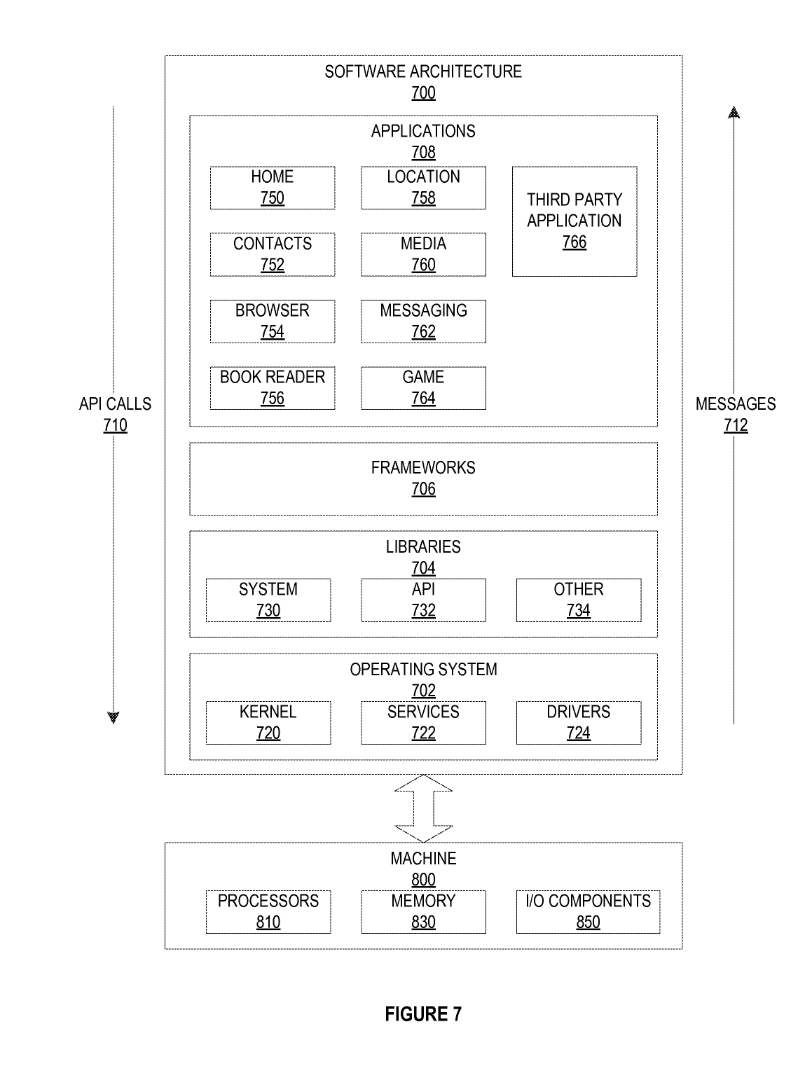

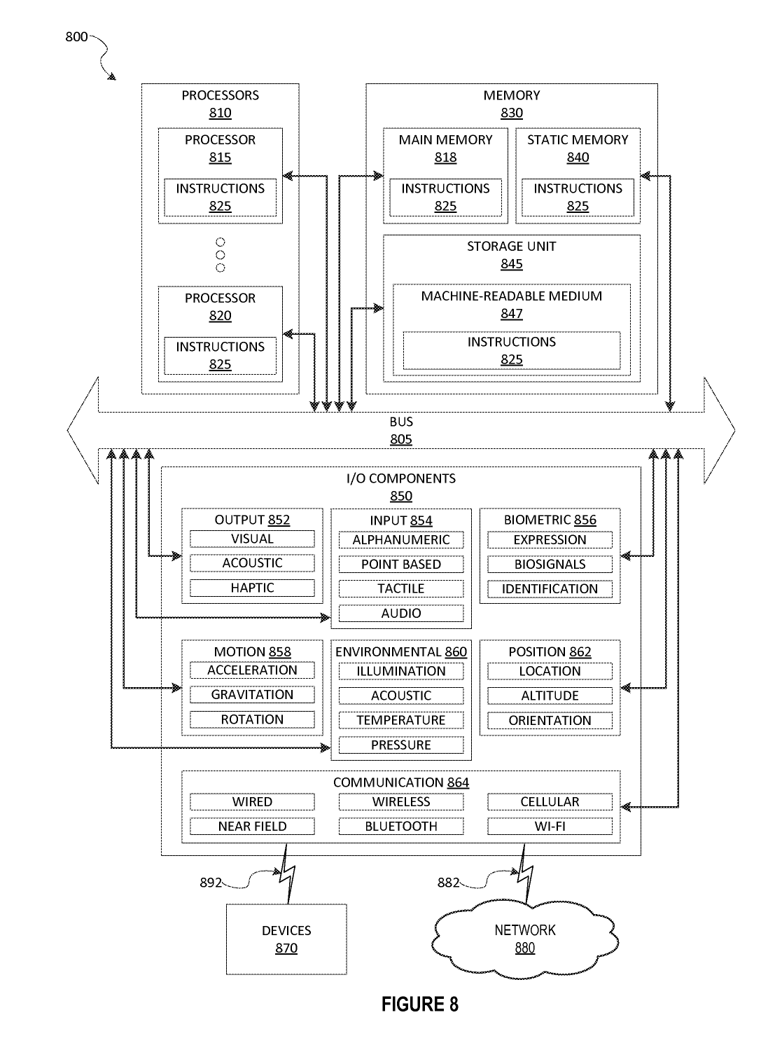

FIG. 7 is a block diagram illustrating an architecture of software 700, in accordance with an example embodiment, which may be installed on any one or more of the devices of FIG. 1 (e.g., the computer device 120). FIG. 7 is merely a non-limiting example of a software architecture and it will be appreciated that many other architectures may be implemented to facilitate the functionality described herein. The software 700 may be executing on hardware such as a machine 800 of FIG. 8 that includes processors 810, memory 830, and I/O components 850. In the example architecture of FIG. 7, the software 700 may be conceptualized as a stack of layers where each layer may provide particular functionality. For example, the software 700 may include layers such as an operating system 702, libraries 704, frameworks 706, and applications 708. Operationally, the applications 708 may invoke application programming interface (API) calls 710 through the software stack and receive messages 712 in response to the API calls 710.

The operating system 702 may manage hardware resources and provide common services. The operating system 702 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling and/or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 704 may provide a low-level common infrastructure that may be utilized by the applications 708. The libraries 704 may include system libraries (e.g., C standard library) 730 that may provide functions such as memory allocation functions, string manipulation functions, mathematic functions, and the like. In addition, the libraries 704 may include API libraries 732 such as media libraries (e.g., libraries to support presentation and manipulation of various media formats, such as MPEG4, H.264, MP3, AAC, AMR, JPG, or PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 704 may also include a wide variety of other libraries 734 to provide many other APIs to the applications 708.

The frameworks 706 may provide a high-level common infrastructure that may be utilized by the applications 708. For example, the frameworks 706 may provide various graphic user interface (GUI) functions, high-level resource management, high-level location services, and so forth. The frameworks 706 may provide a broad spectrum of other APIs that may be utilized by the applications 708, some of which may be specific to a particular operating system or platform.

The applications 708 include a home application 750, a contacts application 752, a browser application 754, a book reader application 756, a location application 758, a media application 760, a messaging application 762, a game application 764, and a broad assortment of other applications, such as a third party application 766. In a specific example, the third party application 766 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 766 may invoke the API calls 710 provided by the operating system 702 to facilitate functionality described herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 825 (e.g., software, a program, an application, an applet, an app, or other executable code) for causing the machine 800 to perform any one or more of the methodologies discussed herein may be executed. In alternative embodiments, the machine 800 operates as a stand-alone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 825, sequentially or otherwise, that specify actions to be taken by the machine 800. Further, while only a single machine 800 is illustrated, the term “machine” shall also be taken to include a collection of machines 800 that individually or jointly execute the instructions 825 to perform any one or more of the methodologies discussed herein.

The machine 800 may include processors 810, memory 830, and I/O components 850, which may be configured to communicate with each other via a bus 805. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 815 and a processor 820 that may execute the instructions 825. The term “processor” is intended to include multi-core processors that may comprise two or more independent processors (also referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 818, a static memory 840, and a storage unit 845 accessible to the processors 810 via the bus 805. The storage unit 845 may include a machine-readable medium 847 on which are stored the instructions 825 embodying any one or more of the methodologies or functions described herein. The instructions 825 may also reside, completely or at least partially, within the main memory 818, within the static memory 840, within at least one of the processors 810 (e.g., within the processor's cache memory), or any suitable combination thereof, during execution thereof by the machine 800. Accordingly, the main memory 818, the static memory 840, and the processors 810 may be considered machine-readable media 847.

As used herein, the term “memory” refers to a machine-readable medium 847 able to store data temporarily or permanently, and may be taken to include, but not be limited to, random-access memory (RAM), read-only memory (ROM), buffer memory, flash memory, and cache memory. While the machine-readable medium 847 is shown in an example embodiment to be a single medium, the term “machine-readable medium” should be taken to include a single medium or multiple media (e.g., a centralized or distributed database, or associated caches and servers) able to store the instructions 825. The term “machine-readable medium” shall also be taken to include any medium, or combination of multiple media, that is capable of storing instructions (e.g., the instructions 825) for execution by a machine (e.g., the machine 800), such that the instructions, when executed by one or more processors of the machine (e.g., the processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 850 may include a wide variety of components to receive input, provide and/or produce output, transmit information, exchange information, capture measurements, and so on. It will be appreciated that the I/O components 850 may include many other components that are not shown in FIG. 8. In various example embodiments, the I/O components 850 may include output components 852 and/or input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or another pointing instrument), tactile input components (e.g., a physical button, a touch screen that provides location and force of touches or touch gestures, and/or other tactile input components), audio input components (e.g., a microphone), and the like.

In further example embodiments, the I/O components 850 may include biometric components 856, motion components 858, environmental components 860, and/or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 862 may include location sensor components (e.g., a Global Position System (GPS) receiver component), altitude sensor components (e.g., altimeters and/or barometers that detect air pressure, from which altitude may be derived), orientation sensor components (e.g., magnetometers), and the like.

Communication may be implemented using a wide variety of technologies. The I/O components 850 may include communication components 864 operable to couple the machine 800 to a network 880 and/or to devices 870 via a coupling 882 and a coupling 892 respectively. For example, the communication components 864 may include a network interface component or another suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine and/or any of a wide variety of peripheral devices (e.g., a peripheral device coupled via a Universal Serial Bus (USB)).

Moreover, the communication components 864 may detect identifiers and/or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 864, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 825 may be transmitted and/or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 825 may be transmitted and/or received using a transmission medium via the coupling 892 (e.g., a peer-to-peer coupling) to the devices 870. The term “transmission medium” shall be taken to include any intangible medium that is capable of storing, encoding, or carrying the instructions 825 for execution by the machine 800, and includes digital or analog communications signals or other intangible media to facilitate communication of such software.

Furthermore, the machine-readable medium 847 is non-transitory (in other words, not having any transitory signals) in that it does not embody a propagating signal. However, labeling the machine-readable medium 847 “non-transitory” should not be construed to mean that the machine-readable medium 847 is incapable of movement; the machine-readable medium 847 should be considered as being transportable from one physical location to another. Additionally, since the machine-readable medium 847 is tangible, the machine-readable medium 847 may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific embodiments. However, the illustrative discussions above are not intended to be exhaustive or to limit the possible embodiments to the precise forms disclosed. Many modifications and variations are possible in view of the above teachings. The embodiments were chosen and described in order to best explain the principles involved and their practical applications, to thereby enable others skilled in the art to best utilize the various embodiments with various modifications as are suited to the particular use contemplated.

It will also be understood that, although the terms “first,” “second,” etc. may be used herein to describe various elements, these elements should not be limited by these terms. These terms are only used to distinguish one element from another. For example, a “first contact” could be termed a “second contact,” and, similarly, a “second contact” could be termed a “first contact,” without departing from the scope of the present embodiments. The first contact and the second contact are both contacts, but they are not the same contact.

The terminology used in the description of the embodiments herein is for the purpose of describing particular embodiments only and is not intended to be limiting. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining (the stated condition or event)” or “in response to determining (the stated condition or event)” or “upon detecting (the stated condition or event)” or “in response to detecting (the stated condition or event),” depending on the context.

This written description uses examples to disclose the inventive subject matter, including the best mode, and also to enable any person skilled in the art to practice the inventive subject matter, including making and using any devices or systems and performing any incorporated methods. The patentable scope of the inventive subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
storing historical time-series data for a plurality of systems;
collecting current time-series data from one or more sensors of a first system;
comparing the current time-series data to the historical time-series data to identify patterns in both the current time-series data and the historical time-series data; and
generating a failure likelihood prediction for the first system based on the identified patterns in the current time-series data and the historical time-series data.

2. The method of claim 1, wherein comparing the current time-series data to the historical time-series data to identify patterns in both the current time-series data and the historical time-series data further comprises:
transforming the historical time-series data for the plurality of systems to a symbolic representation of the historical time-series data;
tokenizing the symbolic representation of the historical time-series data; and
creating a data model based on the tokenized historical time-series data.

3. The method of claim 2, further comprising:
transforming the current time-series data for the first system to a symbolic representation of the current time-series data;
tokenizing the symbolic representation of the current time-series data for the first system;
for each token created from the current time-series data for the first system, analyzing the token to determine whether the token is associated with a system that failed within a predetermined amount of time or did not fail within a predetermined amount of time using the data model; and
determining, based on the analysis of each token created from the current time-series data for the first system, whether the first system is likely to fail within the predetermined amount of time.

4. The method of claim 2, wherein creating the data model based on the tokenized historical time-series data further comprises:
generating a classification model, using the tokens generated from historical data associated with plurality of system and data concerning whether those systems failed, wherein the classification model is able to generate a failure likelihood prediction for a particular system using time series data associated with the particular system.

5. The method of claim 4, wherein comparing the current time-series data to the historical time-series data further comprises:
determining, for current tokenized data associated with the first system, whether the current tokenized data includes one or more tokens associated with systems that failed within the predefined period of time.

6. The method of claim 5, further comprising, in accordance with a determination that the current tokenized data includes one or more tokens associated with systems that failed within the predefined period of time, estimating, based on the number and order of the tokens associated with systems that failed within the predefined period of time, one or more probable system failure points.

7. The method of claim 5, further comprising, in accordance with a determination that the current tokenized data includes one or more tokens associated with systems that failed within the predefined period of time, estimating, based on the number and order of the tokens associated with systems that failed within the predefined period of time, an estimated failure time.

8. The method of claim 1, wherein the historical time-series data for the plurality of systems includes data from at least one system that did fail within the predefined period of time.

9. The method of claim 1, wherein the historical time-series data for the plurality of systems includes data from at least one system that did not fail within a predefined period of time.

10. The method of claim 1, wherein the historical time-series data for the plurality of systems include data from systems with unknown health statuses.

11. An electronic device comprising:
a storage module, using at least one processor of a machine, to store historical time-series data for a plurality of systems;
a collection module, using at least one processor of a machine, to collect current time-series data from one or more sensors of a first system;
a comparison module, using at least one processor of a machine, to compare the current time-series data to the historical time-series data to identify patterns in both the current time-series data and the historical time-series data; and
a generation module, using at least one processor of a machine, to generate a failure likelihood prediction for the first system based on the identified patterns in the current time-series data and the historical time-series data.

12. The device of claim 11, wherein the comparison module for comparing the current time-series data to the historical time-series data to identify patterns in both the current time-series data and the historical time-series data further comprises:
a transformation module, using at least one processor of a machine, to transform the historical time-series data for the plurality of systems to a symbolic representation of the historical time-series data;
a tokenizing module, using at least one processor of a machine, to tokenize the symbolic representation of the historical time-series data; and
a creation module, using at least one processor of a machine, to create a data model based on the tokenized historical time-series data.

13. The device of claim 12, further comprising:
a transformation module, using at least one processor of a machine, to transform the current time-series data for the first system to a symbolic representation of the current time-series data;
a tokenizing module, using at least one processor of a machine, to tokenize the symbolic representation of the current time-series data for the first system;
an analysis module, using at least one processor of a machine, to, for each token created from the current time-series data for the first system, analyze the token to determine whether the token is associated with a system that failed within a predetermined amount of time or did not fail within a predetermined amount of time using the data model; and
a determination module, using at least one processor of a machine, to determine, based on the analysis of each token created from the current time-series data for the first system, whether the first system is likely to fail within the predetermined amount of time.

14. The system of claim 13, wherein the creation module for creating the data model based on the tokenized historical time-series data further comprises:
an identification module, using at least one processor of a machine, to identify first tokens associated with systems that did not fail within a predefined period of time and second tokens associated with systems that did fail within the predefined period of time; and
a generation module, using at least one processor of a machine, to generate a classification model, using the identified tokens, to determine, based on tokens associated with a particular system, whether the particular system is likely to fail within the predefined period of time.

15. The system of claim 14, wherein the classification model is a support vector machine.

16. The system of claim 15, wherein the comparison module for comparing the current time-series data to the historical time-series data further comprises:
a determination module, using at least one processor of a machine, to determine, for current tokenized data associated with the first system, whether the current tokenized data includes one or more tokens associated with systems that failed within the predefined period of time.

17. A non-transitory computer-readable storage medium storing instructions that, when executed by the one or more processors of a machine, cause the machine to perform operations comprising:
storing historical time-series data for a plurality of systems;
collecting current time-series data from one or more sensors of a first system;
comparing the current time-series data to the historical time-series data to identify patterns in both the current time-series data and the historical time-series data; and
generating a failure likelihood prediction for the first system based on the identified patterns in the current time-series data and the historical time-series data.

18. The non-transitory computer-readable storage medium of claim 17, wherein comparing the current time-series data to the historical time-series data to identify patterns in both the current time-series data and the historical time-series data further comprises:
transforming the historical time-series data for the plurality of systems to a symbolic representation of the historical time-series data;
tokenizing the symbolic representation of the historical time-series data; and
creating a data model based on the tokenized historical time-series data.

19. The non-transitory computer-readable storage medium of claim 18, further comprising:
transforming the current time-series data for the first system to a symbolic representation of the current time-series data;
tokenizing the symbolic representation of the current time-series data for the first system;
for each token created from the current time-series data for the first system, analyzing the token to determine whether the token is associated with a system that failed within a predetermined amount of time or did not fail within a predetermined amount of time using the data model; and
determining, based on the analysis of each token created from the current time-series data for the first system, whether the first system is likely to fail within the predetermined amount of time.

20. The non-transitory computer-readable storage medium of claim 18, wherein creating the data model based on the tokenized historical time-series data further comprises:
identifying first tokens associated with systems that did not fail within a predefined period of time and second tokens associated with systems that did fail within the predefined period of time; and
generating a classification model, using the identified tokens, to determine, based on tokens associated with a particular system, whether the particular system is likely to fail within the predefined period of time.
